(19) United States
(12) Patent Application Publication
(10) Pub. No.: US 2019/0243013 A1
(43) Pub. Date: Aug. 8, 2019

(54) Estimation of material loss from 2D digital radiographs using Double Wall Single Imaging (DWSI) Technique

(71) Applicant: Oceaneering International, Inc., Houston, TX (US)

(72) Inventor: Rajashekar Venkatachalam, Cypress, TX (US)

(73) Assignee: Oceaneering International, Inc., Houston, TX (US)

(21) Appl. No.: 16/185,893

(22) Filed: Nov. 9, 2018

Related U.S. Application Data
(60) Provisional application No. 62/583,634, filed on Nov. 9, 2017.

(51) Int. Cl. G01T 7/00

(52) U.S. Cl. CPC G01T 7/005; H05H 11/00

(57) ABSTRACT

Material loss may be estimated from 2D digital radiographs using double wall single imaging (DWSI) technique using a system for estimation of material loss from 2D digital radiographs comprising one or more calibration samples, each with one or more known defects; one or more radiofrequency emissions sources; one or more radiofrequency emissions detectors; one or more radiofrequency emissions processors operatively in communication with at least one radiofrequency emissions detector; and software which is used to process a background image representative of a background proximate a structure which is obtained and radiofrequency emissions emitted the structure at a predetermined location. The radiofrequency emissions detector detects radiofrequency emissions reflected from the structure and the radiofrequency emissions processor used to further process the radiofrequency emissions by creating a two-dimensional image of the detected radiofrequency emissions from which the background image is subtracted using median filtering.

### RELATION TO OTHER APPLICATIONS

This application claims priority through U.S. Provisional Application 62/583,634, filed Nov. 9, 2017.

### BACKGROUND

Double Wall Single Image (DWSI) technique is often used to detect defects in an object that is inspected (such as a pipe) by looking for features in the radiographic image which have higher contrast compared to the background. It is difficult to estimate wall loss information from the radiograph because of variation in gray values due to scatter, object geometry, the actual setup, location of the defect with respect to the center of the detector and variation in dose emitted by the source.

### FIGURES

Various figures are included herein which illustrate aspects of embodiments of the disclosed inventions.

FIG. 1 is block view of an exemplary system for estimation of material loss from 2D digital radiographs using double wall single imaging (DWSI) technique;

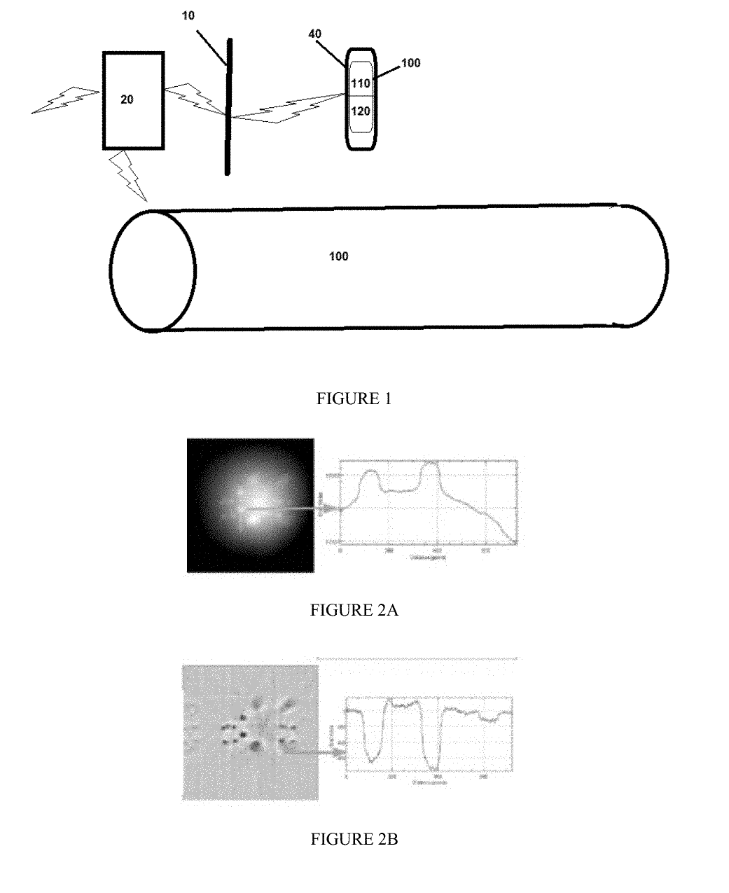

FIGS. 2A-2D are representations of scatter from a structure and minor variation in calibration curves with respect to dose results in wall loss accuracy between 5 to 15% using the method described herein where FIG. 2A is an original image, FIG. 2B is an original image with the background subtracted, FIG. 2C is an image of centered defects from a set of validation samples, and FIG. 2D is an image of non-centered defects from a set of blind samples; and

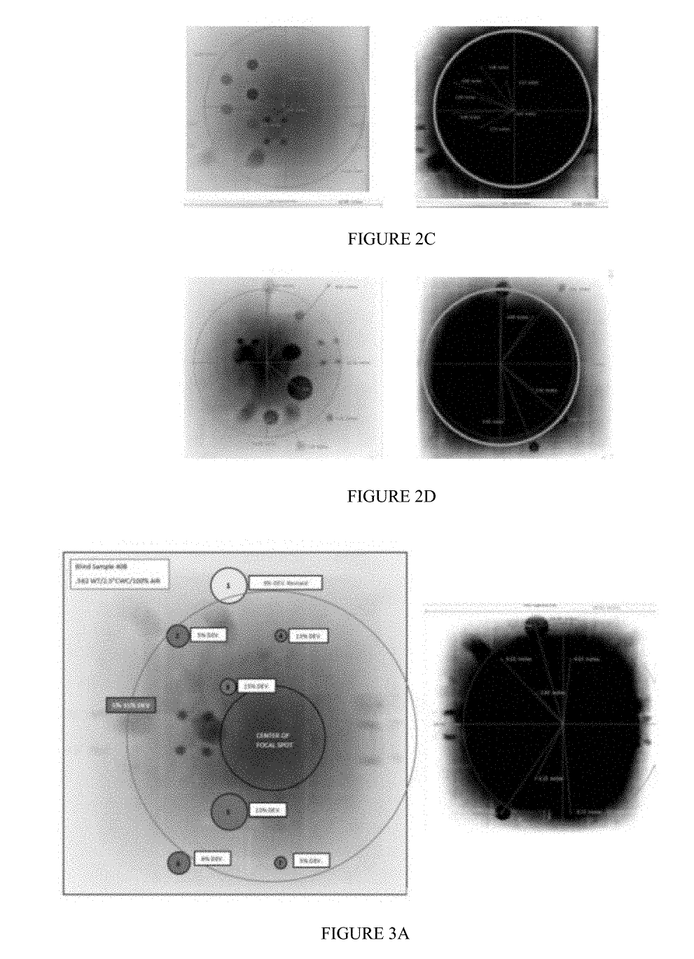

FIGS. 3A-3B are further representations of scatter from a structure and minor variation in calibration curves where FIG. 3A illustrates scatter from a structure and minor variations in calibration curves with respect to dose results in wall loss accuracy between 5 to 15% and FIG. 3B illustrates scatter from a structure and minor variations in calibration curves with respect to dose results in wall loss accuracy between 1 to 17% using the method described herein.

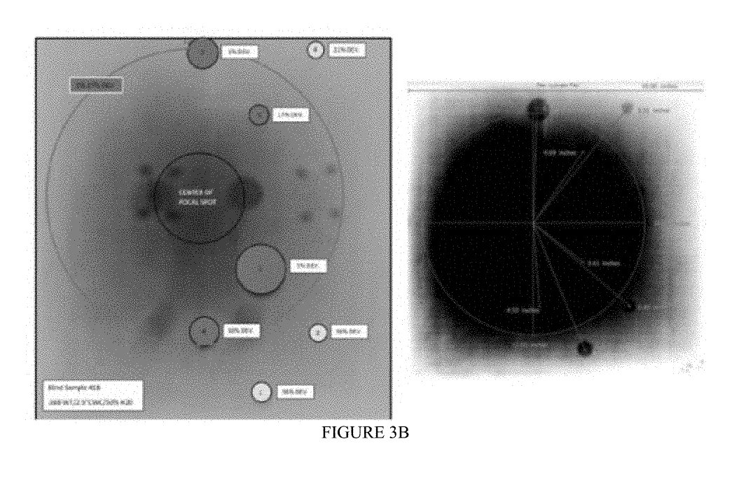

### DESCRIPTION OF EXEMPLARY EMBODIMENTS

System 1 for estimation of material loss from 2D digital radiographs using double wall single imaging (DWSI) technique comprises one or more calibration samples 10, each with one or more known defects; one or more sources 20 of radiofrequency emissions such as a Betatron source; one or more radiofrequency emissions detectors 30; one or more radiofrequency emissions processors 40 operatively in communication with at least one radiofrequency emissions detector 30; and software 100 operative in radiofrequency emissions processor 40.

Software 100 comprises image module 110 capable of creating a two-dimensional image of radiofrequency emissions detected by radiofrequency emissions detector 30 from radiofrequency emissions emitted by source 20 of radiofrequency emissions and calibration module 120 operative to use at least one calibration sample 10 with a known defect to establish a calibration curve between a normalized contrast of a defect indicated by the detected radiofrequency emissions and an actual percentage wall loss.

In the operation of exemplary embodiments, estimation of material loss from 2D digital radiographs using double wall single imaging (DWSI) technique using system 1 as described above comprises obtaining at least one calibration sample 10 with one or more known defects; maneuvering system 1 proximate a structure, which can be a tubular disposed subsea; obtaining a background image representative of a background proximate the structure; emitting radiofrequency emissions from source 20 into the structure at a predetermined location; using radiofrequency emissions detector 30 to detect radiofrequency emissions reflected from the structure; and then using radiofrequency emissions processor 40 to further process the radiofrequency emissions.

To do so, radiofrequency emissions processor 40 creates a two-dimensional image of radiofrequency emissions detected by radiofrequency emissions detector 30 and generates a calibration plot by subtracting the background image from the two-dimensional image of radiofrequency emissions using median filtering. Radiofrequency emissions processor 40 determines a background gray value at the predetermined location and calculates a normalized contrast of a set of known defects based on the background gray value at the predetermined location. It then uses calibration sample 10 to establish a calibration curve between the normalized contrast of the defect and the actual percentage wall loss.

In certain embodiments, these steps are applied to an image of a blind sample; a set of high contrast defects detected; and, for every detected high contrast defect in the set of high contrast defects, the background image is subtracted using median operation, a normalized contrast of the defect determined, and the normalized contrast used to determine a percentage wall loss information using the calibration curve that was previously established.

In certain contemplated embodiments, a stepwedge may be placed on radiofrequency emissions detector 30, where the stepwedge comprises reference thickness information, and the reference thickness information used to correct for wall loss estimate errors that could occur due to variation in content inside the structure and other variations in the actual material of the blind sample with respect to a calibration sample.

In any of these embodiments, radiofrequency emissions detectors 30 may be calibrated when and as needed.

As noted above, the structure can comprise a tubular, either subsea or topside, and, if the structure is or otherwise comprises a tubular which at least partially comprises insulation, the steps described herein can be performed topside and subsea to determine if there is corrosion under insulation.

The foregoing disclosure and description of the inventions are illustrative and explanatory. Various changes in the size, shape, and materials, as well as in the details of the illustrative construction and/or an illustrative method may be made without departing from the spirit of the invention.

1. A system for estimation of material loss from 2D digital radiographs using double wall single imaging (DWSI) technique, comprising:
a. a calibration sample with known defects;
b. a source of radiofrequency emissions;
c. a radiofrequency emissions detector;
d. a radiofrequency emissions processor operatively in communication with the radiofrequency emissions detector; and
e. software operative in the radiofrequency emissions processor, the software comprising:
i. an image module capable of creating a two-dimensional image of radiofrequency emissions detected by the radiofrequency emissions detector from radiofrequency emissions emitted by the source of radiofrequency emissions; and
ii. a calibration module operative to use a calibration sample with known defects to establish a calibration curve between a normalized contrast of a defect indicated by the detected radiofrequency emissions and an actual percentage wall loss.

2. A method of estimation of material loss from 2D digital radiographs using double wall single imaging (DWSI) technique using a system for estimation of material loss from 2D digital radiographs using double wall single imaging (DWSI) technique comprising a source of radiofrequency emissions, a radiofrequency emissions detector, and a radiofrequency emissions processor adapted to create a two-dimensional image of radiofrequency emissions detected by the radiofrequency emissions detector from radiofrequency emissions emitted by the source of radiofrequency emissions and to use a calibration sample with known defects to establish a calibration curve between a normalized contrast of a defect indicated by the detected radiofrequency emissions and an actual percentage wall loss, the method comprising:
a. obtaining a calibration sample with known defects;
b. maneuvering the system for estimation of material loss from 2D digital radiographs using double wall single imaging (DWSI) technique proximate a structure;
c. obtaining a background image representative of a background proximate the structure;
d. emitting radiofrequency emissions from the source of radiofrequency emissions into the structure at a predetermined location;
e. using the radiofrequency emissions detector to detect radiofrequency emissions reflected from the tubular;
f. using the radiofrequency emissions processor to create a two-dimensional image of radiofrequency emissions detected by the radiofrequency emissions detector;
g. using the radiofrequency emissions processor to generate a calibration plot by subtracting the background image from the two-dimensional image of radiofrequency emissions using median filtering;
h. using the radiofrequency emissions processor to determine a background gray value at the predetermined location;
i. using the radiofrequency emissions processor to calculate a normalized contrast of a set of known defects based on the background gray value at the predetermined location; and
j. using the calibration sample with known defects to establish a calibration curve between the normalized contrast of the defect and the actual percentage wall loss.

3. The method of estimation of material loss from 2D digital radiographs using double wall single imaging (DWSI) technique of claim 2, further comprising:
a. applying the steps of claim 2 to an image of a blind sample;
b. detecting a set of high contrast defects; and
c. for every detected high contrast defect in the set of high contrast defects,
i. subtracting the background image using median operation;
ii. determining a normalized contrast of the defect; and
iii. using the normalized contrast to determine a percentage wall loss information using the calibration curve that was previously established.

4. The method of estimation of material loss from 2D digital radiographs using double wall single imaging (DWSI) technique of claim 2, further comprising calibrating the detector at a predetermined time.

5. The method of estimation of material loss from 2D digital radiographs using double wall single imaging (DWSI) technique of claim 2, for a tubular at least partially comprising insulation, further comprising performing the method topside and subsea to determine corrosion under insulation.

6. The method of estimation of material loss from 2D digital radiographs using double wall single imaging (DWSI) technique of claim 2, further comprising:
a. placing a stepwedge on the radiofrequency emissions detector, the stepwedge comprising reference thickness information; and
b. using the reference thickness information to correct for wall loss estimate errors that could occur due to variation in content inside the tubular and other variations in the actual material of the blind sample with respect to a calibration sample.

7. The method of claim 2, wherein the structure comprises a tubular.
